(19) United States
(12) Patent Application Publication
(10) Pub. No.: US 2008/0203328 A1
(43) Pub. Date: Aug. 28, 2008

(54) OUTER SPACE SUN SCREEN FOR REDUCING GLOBAL WARMING

(76) Inventor: Yoram Palti, Haifa (IL)

Correspondence Address: PROSKAUER ROSE LLP;PATENT DEPARTMENT, 1585 BROADWAY, NEW YORK, NY, 10036-8299, US

(21) Appl. No.: 12/035,886

(22) Filed: Feb. 22, 2008

Related U.S. Application Data
(60) Provisional application No. 60/912,587, filed on Apr. 18, 2007.
(60) Provisional application No. 60/891,130, filed on Feb. 22, 2007.

(51) Int. Cl. G21F 3/00; B64D 47/00

(52) U.S. Cl. 250/515.1; 244/1 R

(57) ABSTRACT

A large number of bubbles or other thin-walled hollow objects are deployed in outer space to form a sun screen. Portions of the solar radiation incident on the sun screen are reflected or absorbed. Since those portions will not reach the earth, deploying the sun screen over very large areas can have a significant impact towards reducing global warming.

### CROSS REFERENCE TO RELATED APPLICATIONS

This application claims the benefit of U.S. Provisional Application 60/891,130, filed Feb. 22, 2007, and U.S. Provisional Application 60/912,587, filed Apr. 18, 2007.

### BACKGROUND

Global warming (GW) poses a challenge to humanity. One approach for combating GW is to lower the human activities that may be contributing to the problem (e.g. greenhouse gas emission). But that approach may be very difficult to implement due to the uncertainty regarding what causes GW and the willingness of societies to change their industries and living styles.

### SUMMARY

A plurality of bubbles or other thin-walled objects are deployed in outer space to prevent a portion of the sun's rays from reaching the earth, thereby reducing the global temperature.

### BRIEF DESCRIPTION OF THE DRAWINGS

FIG. 1A depicts the tension—bubble radius relationship at two different pressures.

FIG. 1B depicts the tension-bubble radius relationship in response to an expansion.

FIG. 1C depicts the tension-bubble radius relationship in response to a contraction.

FIG. 2 is a set of spectral transmission curves at different latitudes across a soap bubble.

FIG. 3 is a comparison of the spectral transmission curves of regular soap bubbles and soap bubbles with a reflecting additive.

FIG. 4 depicts a preferred spaceship-mounted apparatus for generating bubbles in space.

FIGS. 5A-D depict a bubble deployment system that uses a first approach for obtaining correct bubble speed upon release.

FIGS. 6A-C depict a bubble deployment system that uses a second approach for obtaining correct bubble speed upon release.

FIGS. 7A-C depict a bubble deployment system that uses a third approach for obtaining correct bubble speed upon release.

### DETAILED DESCRIPTION OF THE PREFERRED EMBODIMENTS

The embodiments described herein combat GW by reducing the intensity of solar insolation, i.e. by lowering the fraction of sun radiation that reaches earth. This approach is expected to be effective regardless of the physical factors and human behavior and compliance. In this approach, elements that serve as a radiation screen are deployed between the sun and earth. Suitable locations for the screens include the stratosphere, in low earth orbit (LEO), a geosynchronous orbit, or a remote location, such as the inner Lagrange point L1, were they are expected to remain stationary with relation to the sun-earth axis.

The screening elements may absorb, but preferably reflect or disperse the sun radiation such that the amount of energy reaching earth is reduced. The screen may be made of elements ranging from microscopic atmospheric particles, such as those that are emitted during volcanic eruptions and proved in the past to effectively screen the sun light, through miniature man made space floating reflectors to giant constructions that incorporate thin screening structures deployed in space.

The total surface area of the radiation attenuating elements must be very large in order to have the required heat reducing effect. It is estimated that to obtain a temperature reduction of 1-2° C., which is considered meaningful from a GW point of view, the total screen area must be well over 100,000 km².

A major factor that determines the applicability of any type of screen is the screening efficacy which determines the required total area of screening elements. A dominant factor that determines the feasibility of any system is the large amounts of materials necessary to construct the enormous screen and the corresponding cost associated with getting it to its final position.

One possible solution is to build an ultra-thin planar structure or structures in order to minimize the involved weight. However, in-spite of the gravitation free environment, which in principle allows for ultra-thin structures to maintain their geometrical structure, the individual unit can not be too thin or too large as radiation pressure and the momentum delivered by meteorites will eventually disrupt, distort or disorient the units which have nothing to hold them in position. Radiation pressure is the momentum that the sun light, as well as other radiations, impose on all objects. While the forces involved are very small, in the relevant environment they will affect the free floating objects. The result would be that all irradiated objects will be slowly dislocated with time. Note also that planar objects and other objects that are not perfectly homogeneous and symmetric with respect to the impeding radiation will experience a torque that will eventually cause it to orient such as to minimize the forces acting on it. For example, a planar object will orient its flat (reflective) plane parallel to the radiation direction and thus will stop serving as an effective screen. It can be calculated, for example, that a 1 m² glass reflector 1μ thick, with a 5% effective inhomogeneity, initially positioned perpendicular to the radiation, will orient parallel to the radiation within less then 1 hour.

Another possible solution is to deploy a large number of small objects, e.g., spheres, in the desired location in outer space, between the sun and earth. Using spheres is advantageous because with a 3D symmetric object such as a sphere, the screening efficacy is not be affected by the radiation pressure even when its surface properties are not uniformly distributed. In fact, under such conditions the torque will cause the spheres to rotate about their axes thus stabilizing them. In addition, the rotation will cause the surface facing the sun to change continuously (provided that the axis of rotation is not parallel to the sun's rays), thereby minimizing the buildup of large temperature gradients across the sphere. Optionally, such a beneficial rotation may be purposely induced during the spheres' deployment.

Note that from a structural strength point of view, spheres have advantage relative to other geometric shapes. Note also that the smaller the sphere radius, the stronger are its mechanical properties. Whatever shape is used, it is preferable for it to be hollow with very thin walls to reduce the weight of the material that must be transported into space.

A first approach for making hollow, ultra-thin walled structures is by blowing bubbles. Preferably, the material is transported to space as solid or liquid, and then blown up to form the bubbles in space. The viability of forming bubbles in outer space is described in Self-Deployed Space or Planetary Habitats and Extremely Large Structures, Final Report Covering the Period 1 Sep. 2006 to 31 Mar. 2007, University Space Research Association (USRA) and NASA Institute for Advanced Concepts (NIAC), by D. Crowe, et al., June 2007. That document is incorporated herein by reference in its entirety. The embodiment that uses bubbles is referred to herein as the Sun Radiation Screening, or SRS System. SRS utilizes “clouds” of Space Bubbles (SB) to serve as a screen between the sun and earth. The Space Bubbles are similar to the soap bubbles that are commonly generated by children's bubble blowers.

Some characteristics of bubbles that help make them suitable for this application are: (a) their walls are extremely thin, approaching double molecular layer dimensions, so their mass is extremely small; (b) their extremely favorable ratio between their wall material volume and the area they cover; (c) they are easy to generate by agitating, blowing air or gas into a membrane consisting of a proper solution, etc.; (d) their spherical shape makes them structurally robust in spite of their ultra-thin walls; (e) they reflect a significant fraction of the light that reaches them; (f) they can be made out of a large choice of materials; (g) colored bubbles and bubbles coated with molecular layer of metal can be made; (h) bubble properties can be selected to specifically reflect a desired fraction of the light spectrum; (i) reflectance and mechanical strength can be varied by changing the bubble diameter; (j) bubbles can unite and remain mechanically stable in the united state; (k) the amount of gas needed to maintain a bubble in vacuum (space) is extremely small; and (l) in space the evaporation of any volatile material, which may serve as a solvent for the materials designated to form the SB wall, is much more rapid.

Thin walled bubbles can be made out of water, detergent, glycerin, etc. (i.e., conventional soap bubbles), or from various polymers, etc. by blowing. To prevent bubbles from expanding when exposed to the vacuum in space until they rupture, the bubbles may be blown using a very small amount of air or other gas such that its expansion will be checked by the elastic forces of the bubble membrane, using techniques known to persons skilled in the relevant arts. A preferred size for the SBs is between about 1 mm and about 10 mm.

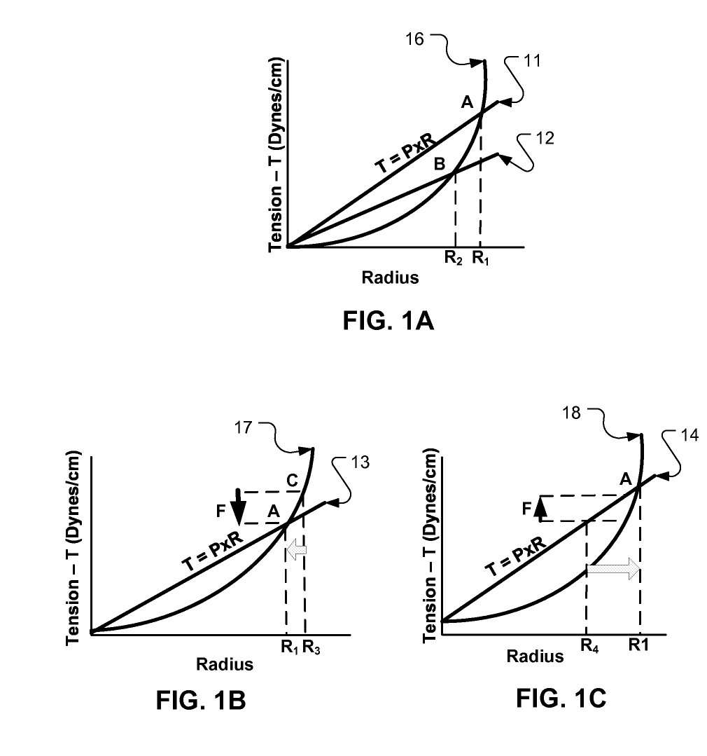

FIGS. 1A, 1B, and 1C depict the tension-bubble radius relationships and the sphere's behavior under such conditions. The graphs are based on the behavior of a spherical expandable body as predicted by Laplace's law for a sphere:

P=2T/R, (T=P×R/2)

Where P is the inside Pressure, T is the Tension and R is the Radius. Laplace's law is given by the straight lines 11-14, and the elasticity curve of the sphere wall is given by the curves 16, 17, and 18. The actual line slopes or shapes were chosen arbitrarily as being typical of relevant bodies. Since the sphere obeys both the Laplace and Elasticity relationships, for internal Pressure P₁ at equilibrium, the bubble Radius R₁ is given by the intersection point A. A lower pressure P₂ produces, for example, the corresponding intersection point B and Radius R₂, as shown in FIG. 1A. In designing the sphere one should choose materials and an inflation procedure that will give wall characteristics that will provide the desired sphere size, etc. These radii are stable equilibrium points as demonstrated in FIGS. 1B-C. More specifically, FIG. 1B illustrates that if for some reason the bubble radius is increased to R₃, the elastic force F will bring back the sphere radius to the equilibrium point A. In other words, the sphere will shrink back to its original size. Similarly, FIG. 1C illustrates that if for some reason the bubble radius is decreased to R₄, the force F will bring it back to R₁. The same analysis is valid for both bubbles generated in normal atmosphere, where the pressure values P represent the pressure difference across the bubble wall, as well as bubbles in a vacuum where P represents the internal pressure.

Note that when water solutions are used to generate bubbles, the “free” water evaporates from the bubble wall rapidly so that its thickness is reduced to reach the range of 0.1-0.01μ, as is evident from the colorful light interference images. Such bubbles can be quite stable, with stability being a function of temperature and humidity.

Under normal “earthly” ambient conditions bubbles have a relatively short lifetime. But it is generally accepted that the bubbles burst because of gravitational forces and air movements-mechanical stress, so it is expected that they will survive in space for much longer periods and possibly indefinitely. Water evaporation is over within a very short time and bubbles have been reported to well survive vacuums.

The stability at low temperatures is important as objects in space may attain low temperatures, depending on the relative magnitudes of their light absorption, reflection and radiation. These parameters can be selected and modified as demonstrated below. Note that it has been demonstrated that “soap” bubbles survive well in the frozen state and even if they suffer from cracks due to temperature changes, these would not interfere with their screening efficacy in space.

Thin walled stable bubbles can be manufactured from a large variety of materials other than conventional soap bubbles. For example, from polymers such as vinyl acetate, or from a mixture of diisocyanate, polypropylene glycol monomethacrylate and a fluoropolymer surfactant, etc. Since bubbles suspended in space may attain relatively low temperatures, it is interesting to examine effect of lowering temperature on the stability of bubbles. Table 1 compares the life span of water and vinyl acetate bubbles suspended in air at 25° C. and 1° C. We see that soap bubbles are stable for many days at low temperature, regardless of the humidity. In fact, some remained stable for the duration of our 14-15 day monitoring period. In contrast, polymer bubbles are stable at room temperature, preferably at low humidity.

TABLE 1

| | Room Temperature | | Low Temperature | |
|---|---|---|---|---|
| Bubble Type | High Humidity | Low Humidity | High Humidity | Low Humidity |
| “Soap” | 72.6 ± 68 min, | 4.3 ± 8.6 min, | 6.7 ± 6.6 days, | 7.7 ± 6.6 days, |
| | Range 3-167 min, | Range 0.4-25 min, | Range 0.01-14 | Range 0.01-15 |
| | n = 50 | n = 30 | days, n = 10 | days, n = 14 |
| | P < 0.00002 | | P - insignificant | |
| Polymer (vinyl | 8.8 ± 8.7 hours, | 7.4 ± 3.3 days, | 30 ± 18 min, | 14 ± 8 hours |
| acetate) | Range 1-25 hours, | Range 3-14 days, | Range 2-60 min, | Range 6-24 |
| | n = 50 | n = 20 | n = 20 | hours, n = 10 |

| | |
|---|---|
| P < 0.00002 | P < 0.00002 |

Measurements were made of the average values of light attenuation caused by water based bubbles interposed between a light source and a sensor. It was observed that the attenuation is maximal (transmission being 60-70%) near the bubble edge 33 and it levels off in the bubble's mid section where its transmission values are in the range of 85-90%. The average attenuation for “soap” bubbles of a diameter close to and above 10 mm is approximately 17%—transmission 87% (computed by integrating over the entire bubble). Since the outer rim (width 1-2 mm) of bubbles has a much larger light attenuation, the smaller the bubble the higher the average attenuation per bubble. Thus, by blanketing an area with a layer of very small bubbles, the total attenuation can be maximized. Note that a screen of bubbles, consisting of one layer of closely packed bubbles, requires the same amount of raw material to form the bubbles regardless of the bubbles' size. This is due to the fact that the total surface area of spheres making up such a layer is independent of the sphere radius.

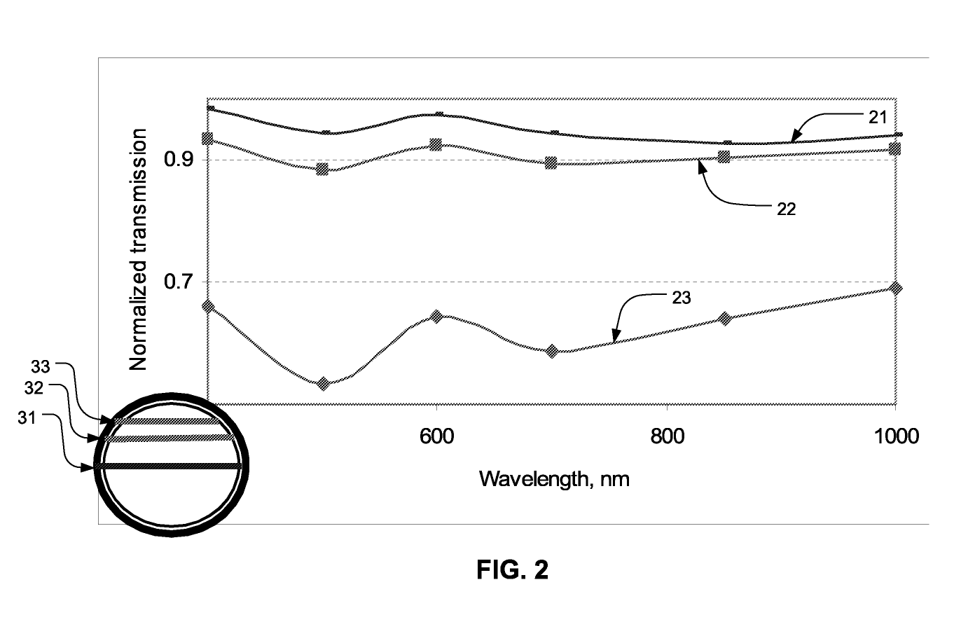

FIG. 2 depicts a set of normalized spectral transmission curves 21, 22, 23 of a soap bubble at three different latitudes across the bubble 31, 32, 33, respectively. It is seen that the differences along the curves 21, 22 are small near the equator 31 and increases to about 25% at latitudes 33 approaching the poles. The transmission attenuation is effective in all wavelengths, from UV to IR.

Since different types of bubbles will have different characteristics, the attenuation characteristics of three different types of bubbles are set forth in Table 2.

TABLE 2

| Bubble | | Wavelength | | | | | |
|---|---|---|---|---|---|---|---|
| type | | 400 | 500 | 600 | 700 | 850 | 1000 |
| Soap | Total | 87% | 83% | 90% | 83% | 84% | 86% |
| (n = 10) | transmission | | | | | | |
| | Attenuation | 13% | 17% | 10% | 17% | 16% | 14% |
| Soap | Total | 84% | 82% | 87% | 83% | 83% | 86% |
| silver | transmission | | | | | | |
| infused | Attenuation | 16% | 18% | 13% | 17% | 17% | 14% |
| (n = 10) | | | | | | | |
| Polymer | Total | 83% | 80% | 86% | 83% | 86% | 90% |
| (n = 10) | transmission | | | | | | |
| | Attenuation | 17% | 20% | 14% | 17% | 14% | 10% |

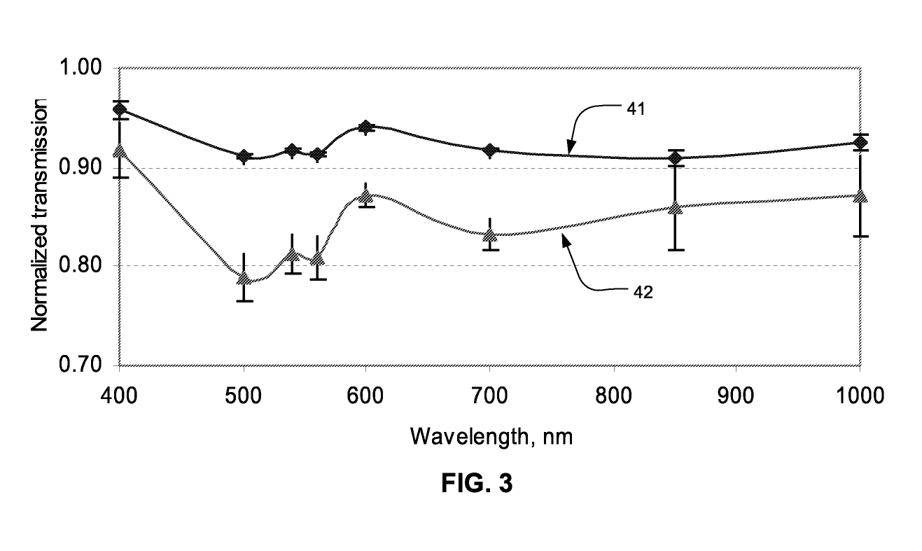

Incorporating reflecting micro-units or molecules (e.g., silver) into the surface of the bubbles may provide significantly higher light attenuation. FIG. 3 compares the light transmission 41 through regular soap bubbles and the light transmission 42 of soap bubbles made with a reflecting additive. The silver color inclusion in the soap bubble preparation solution results in higher attenuation. The maximal transmission attenuation, mostly by reflection, of the “silvered” bubbles is 22% while that of regular soap bubbles is only 8% (at 500 nm). Over the whole spectrum, the attenuation is over twice as large in the “silvered” bubbles.

“Silvered” bubbles can be made by adding finally ground metal flakes or some other shaped metallic powder, such as those frequently used in metallic paints, to the base materials for making ordinary bubbles. The additives may have a mean particle size of between about 0.001 square inches and about 0.01 square inches. One suitable example is water based acrylic metallic paint, such as DecoArt DA70 (Stanford Ky. 40484). That paint is an acrylic emulsion that contains tiny spheres of polymers held in suspension in water. The DecoArt silver acrylic paint was mixed into the “soap” bubble solution at a concentration of between 5% and 20%. Metals other than silver with good reflecting power, and the ability to be incorporated in suspensions mixed with the bubble forming solution may also be used, as can reflecting glass or silica particles.

Note that instead of soap bubbles, the bubbles may be blown from another appropriate solution or medium such that, once formed, their outer wall hardens so that the bubble does not collapse as the solvent or vehicle included in the wall evaporates and the internal gas slowly diffuses out. The bubbles can be blown out of a water solution in which the appropriate materials (including surfactants) are dissolved or from other solvents such as organic solvents (e.g., benzene, alcohols, carbon tetrachloride, etc.) in which carbon based materials, plastics, etc. can be dissolved or any appropriate hydrophobic or hydrophilic fluid. As such solvents are often volatile, they rapidly evaporate leaving a thin walled durable bubble. The required amount of air or other gas in the bubble can be incorporated in it during its production by injection or alternatively an appropriate amount of gas can be generated in it by a chemical reaction that produces a gas (e.g., CO₂) when triggered (e.g., by light, UV radiation, temperature change, etc.)

The bubbles may be deployed so that they (for the most part) do not touch each other. Alternatively, they may be deployed so that most of them will touch. When made of appropriate materials, bubbles that touch will stick together, so they can be formed into a blanket-like structure that is very large (e.g., on the order of hundreds or thousands of meters) in two dimensions, and thin in the third dimension (e.g., on the order of 1-50 mm). This third dimension may be one layer thick or may be made of multiple layers of bubbles (with each layer having the thickness of a single layer of bubbles).

The SBs may be deployed by a space craft that is configured to generate and output a sheet of SBs with the desired SB diameter and density, and spread them in space. The SBs should be ejected at the proper speed so that they leave the spacecraft with the correct velocity to maintain the desired orbit. Depending on the height of orbit, the bubble speed can be adjusted to stay fixed in space such that it screens a selected area of the earth. Optionally, each successive orbit of the spacecraft may be slightly shifted to extend the SB to a new area. Depending on the longevity of the SBs the process may be repeated. The bubble size, density and the dimensions of the sheet may be adjusted so as to screen out the required amount of light. If desired, the screening power can be controlled and fragmented to selected areas, and damaged areas of the screen can be repaired by laying down new bubbles.

For SB's with a surface area A≈1 cm², made from a wall material that has a specific density of 1 g/cm³ and a wall thickness of 10⁻⁶ cm , the volume of the SB wall will be about 10-6 cm³, and the weight will be about 10⁻⁶ g. The number of SBs packed in one layer per 1 km² is about 4×10¹⁰, so the weight of 1 km² packed monolayer screen will be about 40 Kg. To save on material and the cost of lifting that material into space, the deployed SBs can be collected and reused by a suitable configured space craft. Only the volatile materials would have to be replaced.

Notably, because of the spherical fragmented structure of the SRS, it does not need a structural skeleton and is hardly affected by orbiting meteorites, man made space debris, etc. Preferably the longevity of the screen can be optimized by choosing a material that does not evaporate too fast, and space pollution can be reduced or eliminated by choosing a material that it evaporates with time.

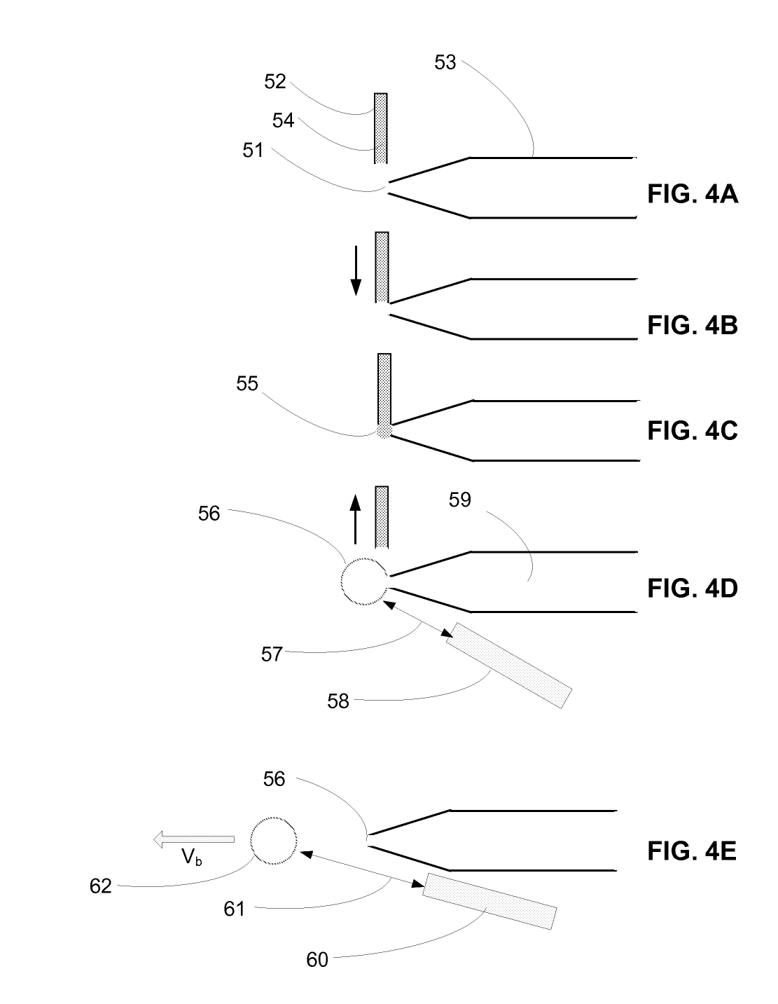

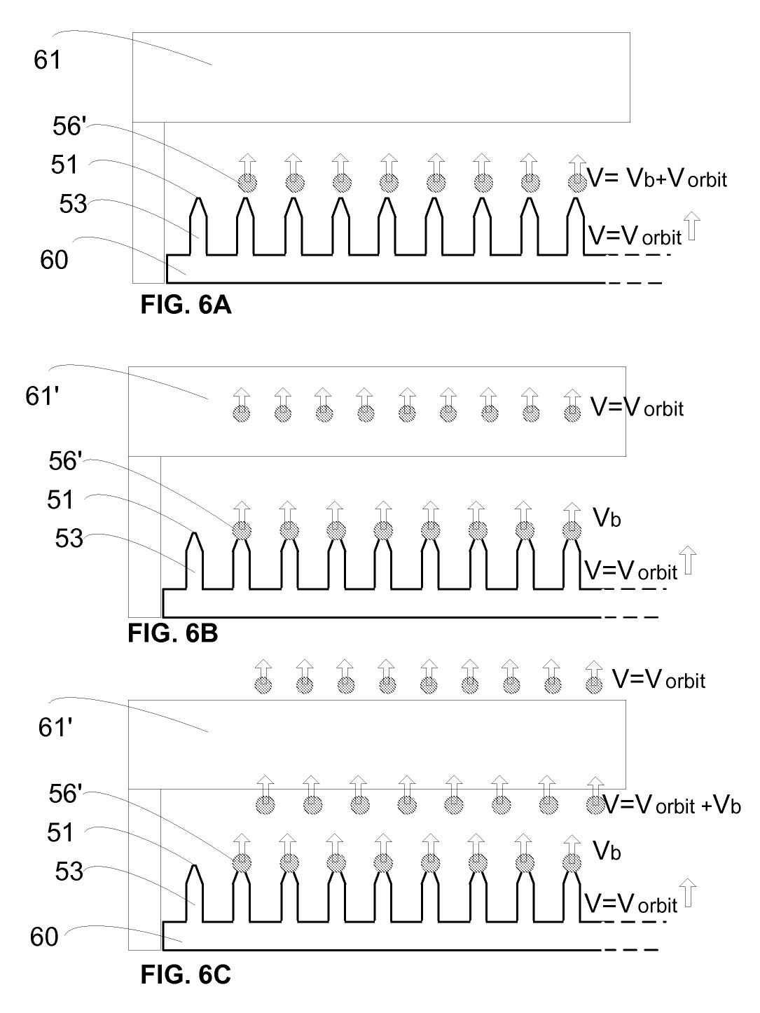

FIG. 4 depicts a preferred spaceship-mounted apparatus for generating the space bubbles 56. The apparatus uses a series of nozzles 51 positioned at the tips of a series of hollow chambers 53 filled with the gas 59 designed to blow the bubbles. Gas pressure pulses are fed to the chambers 53 from the gas & pressure Source vessel 60 (shown in FIG. 6). The pulse amplitude, shape and timing used to blow the bubbles are preferably under computer control. The open end of a tube 52, is positioned close to the nozzle, containing the bubble forming material 54, distributes a mass amount of bubble forming material 55 to each nozzle 51, preferably also under computer control. After the placement of the mass 55, a pressure pulse in chamber 53 blows a bubble 56 from the mass 55. Formation of the bubbles is preferably under continuous monitoring by sensors 58, which preferably operate by using an optic beam 57 to monitor the shape, size, optic properties, detachment, etc. of the bubble. Preferably, the pressure pulse and pulses generation are adjusted in response to signals from the sensors 58.

Since the exit velocity is important, it is preferable to monitor that velocity, and a sensor 60 monitors the velocity of the bubble relative to that of the space vehicle, V_{b} following their detachment, as seen in FIG. 4E. This may be done, for example, using laser Doppler (indicated by beam 61). Optionally, the chambers 53 can rotate on their axis such to impart a rotation onto the released bubbles.

Suitable sensors may be included to monitor the SB gas pressure as SBs are formed; the volume of the gas in the SB as it is being formed, the SB dimensions, the reflectance of the SB as it is being formed, and the wall thickness of the SB as it is being formed. Optionally, monitoring systems located on earth or in space continuously scan the relevant screen areas to detect the screen radiation reduction efficacy. This efficacy is a function of the SB density and structural state. On the basis of this data, a spacecraft may be sent to repair or augment the screening power as required.

The bubbles that detach from the nozzle may move by some speed V_{B} relative to the spacecraft. This bubble velocity is an almost negligible fraction of an orbiting space vehicle speed and therefore will result in a minute change of bubble orbit height (for both LEO and geostationary orbits). To avoid positioning errors one of the following mechanisms discussed below can be employed. Note that in the mechanisms discussed below, the blowing of the bubbles and their release is achieved by an appropriately timed bubble pulse, and the bubble speed is preferably monitored as illustrated in FIG. 4E.

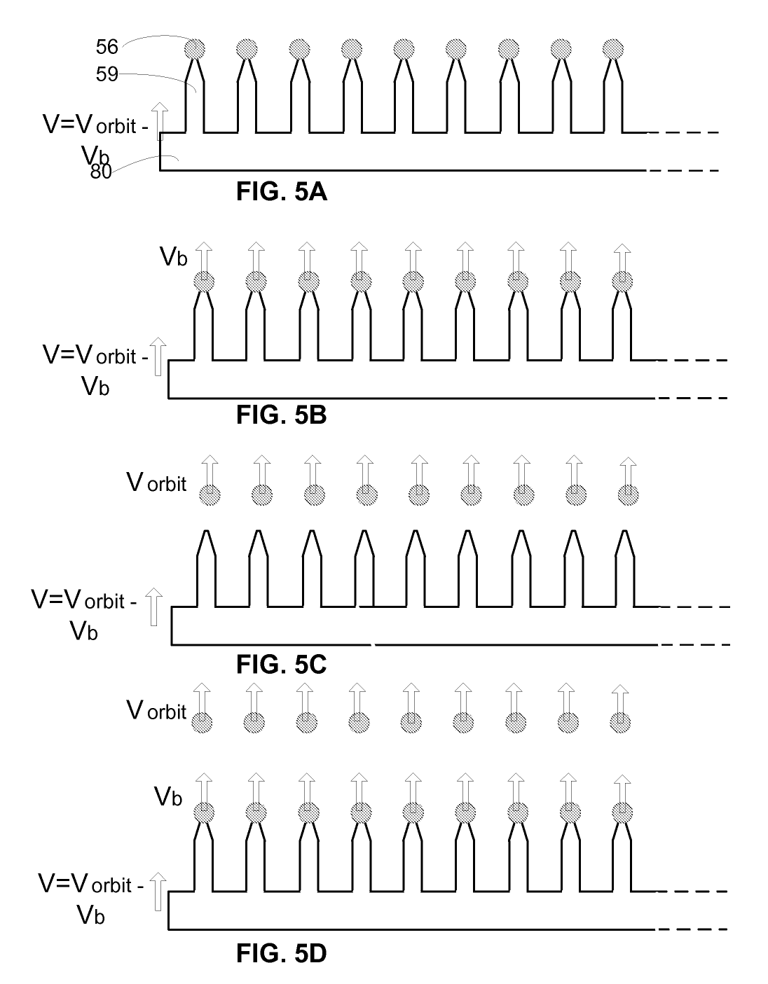

FIGS. 5A-D depict a first bubble deployment system that corrects for such speed errors. The bubble generating system has a series of nozzles 59. Assuming that the bubbles are released from the bubble generating system 80 at a velocity V_{B}, relative to the launching craft at the proper direction (as shown in FIGS. 5B and 5C), and the correct speed that maintains the bubbles at the correct position is V_{ORBIT}, than the craft deploying the bubbles should move at a velocity of V_{ORBIT}−V_{B}. Under these conditions the bubbles are moving faster than the craft so that the distance between them grows, as depicted in FIG. 5D. When the correct distance between the previously-ejected row or set of bubbles and craft reached the desired value, the next set of bubbles is deployed.

FIGS. 6A-C depict another bubble deployment system to ensure that the deployed bubbles travel at the correct velocity. Here the deployment system travels at velocity V=V_{ORBIT}, and is equipped with a pair of electromagnetic plates 61 positioned such that the released bubbles 56′ that include minute amounts of ferromagnetic material, or the like, in their walls are ejected (as shown in FIG. 6A) at a speed V=V_{ORBIT}+V_{B} towards the space between the two plates (as shown in FIG. 6B). As the bubbles reach the space between the plates, they are activated briefly by switching the current on. The magnetic field that is generated holds the bubbles in place between the two plates at which point their velocity becomes V=V_{ORBIT} and remains so after the magnets are switched off. After that, the next set of bubbles is ejected (as shown in FIG. 6C). Suitable ferromagnetic and ferromagnetic materials for this application include, but are not limited to, Co, Fe, FeOFe₂O₃, NiOFe₂O₃, CuOFe₂O₃, MgOFe₂O₃, MnBi, Ni, MnSb, MnOFe₂O₃, Y₃Fe₅O₁₂, CrO₂, MnAs, Gd, Dy, and EuO.

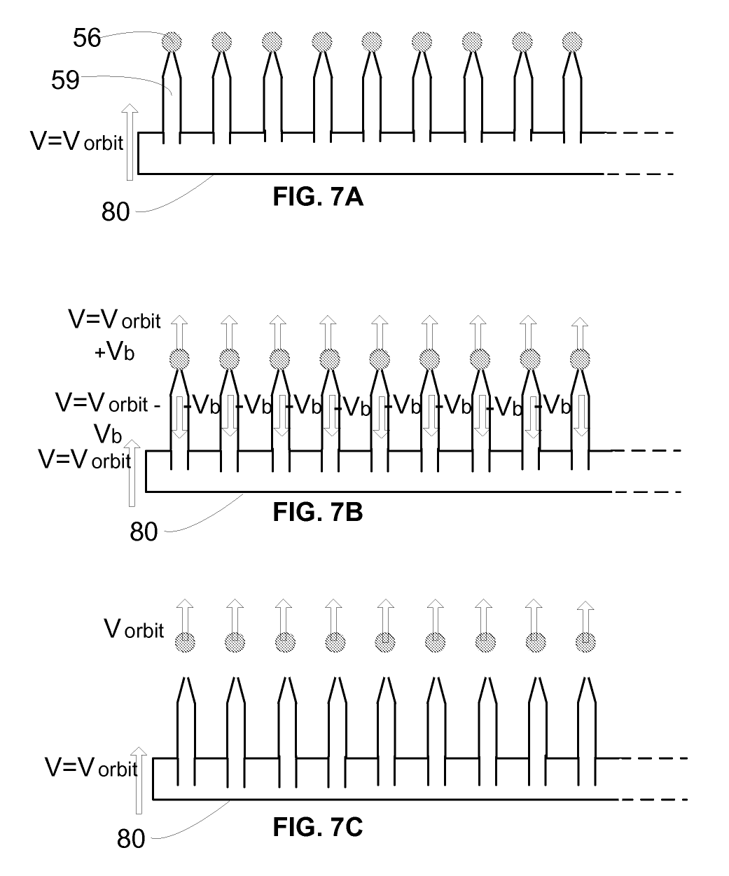

FIGS. 7A-C depict yet another bubble deployment system to ensure that the deployed bubbles travel at the correct velocity. Here the deployment system 80, with bubbles 56 positioned on chambers 53, travels at the orbit speed V=V_{ORBIT}, as shown in FIG. 7A. The released bubbles travel at a velocity V_{B} with respect to the nozzles 59 when they are released. So if the nozzles are moved in the opposite direction at velocity −V_{B} at the moment the bubbles are released, as shown in FIG. 7B, the final velocity of bubbles 56 will be V_{ORBIT}, as shown in FIG. 7C.

There are a number of preferred positions or orbits at which the bubbles can be placed so as to have the desired screening effects. One preferred position is in orbit around earth, for example, at an altitude of a few hundred miles. Under such conditions, obviously, a screen of limited extent (not covering the whole extent of the orbit) will be effective only about half of the time. A screen that is wrapped around the whole earth circumference (like a belt) will be effective all the time, but only half of it will effective at any given moment. A second preferred position is in a high orbit, for example at about 36,000 miles so as to be fixed or stationary with respect to any selected area on earth. Such a screen will reduce the illumination at the selected area or up to half the hemisphere whenever it is subjected to sun light. A third preferred position is at the Lagrangian point L1 in space. At this position it will always be interposed between the sun and earth, casting its shadow while orbiting together with earth around the sun.

Whichever screen position is selected, the radiation force in the direction of earth's gravitation force must be accounted for. Thus, if the screen orbits around earth, its speed has to be higher than it would otherwise be were the radiation force not there. The modification of the speed should preferably exactly offset the apparent increase in the earth's gravitation, or the effective decrease in the sun's gravitational force. Note that at both the fixed geosynchronous orbit and the L1 position the screen is under a constant effect of radiation and the correction in speed or orbital period can be constant and should persist for very long periods of time. For a screen orbiting around earth in an un-fixed orbit, the radiation force fluctuates periodically and with it there will be corresponding fluctuations in the screen speed and orbital period.

Note that the effect of screening different areas on earth varies with territory. A screen over areas where the sun rays reach the earth surface at a steep angle is less effective in absolute terms, and the efficacy of a screen over the ocean, which reflects back most of the impeding light, is very different from one hovering over a land mass, an ice mass, etc.

An alternative embodiment is referred to herein as the Multi Sphere Radiation Screen, or MSRS. The MSRS utilizes “clouds” or “sheets” consisting of small (for example in the mm to cm range) ultra-thin walled spheres instead of the bubbles of the SB embodiment. These spheres also reduce the amount of radiation reaching the earth surface by their reflecting and radiation absorbing surface properties. A single or multi layer sheet of spheres of the appropriate diameter and density can be used.

The MSRS spheres are preferably hollow, ultra-thin walled spheres that are preferably prefabricated in a condensed form on the ground or some other base. These spheres may be constructed of an ultra-thin wall material, made from example from a thin sheet of plastic; nylon, polyethylene, polycarbonate, PVC, latex, rubber, etc. The material should preferably be as impermeable to the gas the spheres contain as possible, (e.g., butyl rubber which is highly impermeable to gases). When manufactured, the spheres should preferably contain a very small amount of air or gas such that when exposed to the vacuum of space the expanding gas will inflate them. The volume of gas is preferably calibrated to provide to the correct size and pressure that is counter-balanced by the wall elasticity and surface tension and does not exceed the wall structural strength to avoid ruptures. The low initial gas pressure during manufacturing can be achieved, for example, by sealing off of the spheres in low pressure gas or air. The basic spherical structure can be made by vacuum forming that will stretch and shape the thin wall leaving a small opening that will be sealed, for example, by heat welding. Once in space, after exposure to vacuum, UV light, low temperature, etc. the wall should attain sufficient structural rigidity to maintain the spherical shape for long periods of time despite loss of gas, etc. Optionally, to help maintain the spherical shape, wall thickenings or circular wires may be integrated in the spheres.

The equilibrium temperature of a black body positioned in space not too far from earth in sun light is about 5-6° C. Optionally, the spheres may be treated to control optical characteristics like transmissivity and reflectivity, so as to improve the screening of the earth and to control the temperature of the spheres in space when subjected to solar radiation (e.g., to prevent overheating). This may be accomplished, for example, by coated by a reflecting layer of molecular thickness of a metallic nature, or by adding dyes. The coating can be separated from the original support.

Optionally, an electrical charge may be applied to the spheres, with similar or opposite charge, so that they cling together or maintain distance according to the need. Note that while spheres are preferred because using spheres simplifies the manufacturing process, other shapes may be used in less preferred embodiments.

I claim:

1. An apparatus for reducing global warming comprising:
a plurality of hollow objects disposed at a location in outer space that lies between the sun and the earth, wherein the hollow objects are all disposed at substantially the same distance from the center of the earth,
wherein each of the hollow objects prevents at least a portion of the sunlight impinging thereon from reaching the surface of the earth, and wherein the hollow objects collectively provide partial shade to at least one square km of the earth's surface.

2. The apparatus of claim 1, wherein each of the hollow objects prevents at least a portion of the sunlight impinging thereon from reaching the earth by reflecting the sunlight.

3. The apparatus of claim 1, wherein most of the hollow objects are disposed close enough to touch at least one neighboring hollow object.

4. The apparatus of claim 1, wherein most of the hollow objects are disposed far enough apart so as not to touch any neighboring hollow object.

5. The apparatus of claim 1, wherein the hollow objects comprise bubbles.

6. The apparatus of claim 1, wherein the hollow objects comprise spheres.

7. The apparatus of claim 1, wherein most of the hollow objects are between 1 and 10 mm in diameter.

8. The apparatus of claim 1, wherein the optical properties of the hollow objects provides a balance between absorbed energy and emitted energy, so as to keep the temperature of the hollow objects within an acceptable range.

9. The apparatus of claim 1, wherein a majority of the hollow objects spin about an axis that is roughly perpendicular to the sun's rays.

10. The apparatus of claim 1, wherein the hollow objects collectively provide partial shade to at least 100,000 square km of the earth's surface.

11. A method of reducing warming of a planet, the method comprising the steps of:
transporting a material for forming bubbles into outer space;
forming thin-walled bubbles using the material; and
deploying the bubbles from a spaceship so that the bubbles have a velocity with respect to the planet that causes the bubbles to settle into a substantially stable orbit,
wherein the bubbles are oriented with respect to the planet so that they partially shade at least one square km of the planet's surface from radiation emanating from the sun.

12. The method of claim 11, wherein control of the velocity of the spacecraft accounts for the exit velocity of the bubbles from the spacecraft.

13. The method of claim 11, wherein the bubbles include a material that enhances reflection.

14. The method of claim 11, wherein most of the bubbles are between 1 and 10 mm in diameter.

15. The method of claim 11, wherein the bubbles are oriented with respect to the planet so that they partially shade at least 100,000 square km of the planet's surface from radiation emanating from the sun.

16. The method of claim 11, wherein the bubbles are arranged in at least one sheet-like structure, with most of the bubbles in any given sheet-like structure touching at least one neighboring bubble.

17. The method of claim 11, wherein most of the bubbles do not touch any neighboring bubbles.

18. The method of claim 11, wherein the deploying step comprises the step of imparting a spin on the bubbles.

19. A method for reducing global warming comprising the step of:
deploying a plurality of thin-walled bubbles at a location in outer space, wherein the bubbles are oriented with respect to the earth so that they partially shade at least one square km of the earth's surface from radiation emanating from the sun.

20. The method of claim 19, wherein the bubbles are deployed at or near the Lagrange L1 point between the sun and the earth.

21. The method of claim 19, wherein the bubbles are deployed in an orbit about the earth.

22. The method of claim 19, wherein the bubbles are deployed in a geosynchronous orbit about the earth.

23. The method of claim 19, wherein the bubbles are formed from at least one of soap water and vinyl acetate.

24. The method of claim 19, wherein the bubbles include a material that enhances reflection.

25. The method of claim 19, wherein most of the bubbles are between 1 and 10 mm in diameter.

26. The method of claim 19, wherein the bubbles are oriented with respect to the earth so that they partially shade at least 100,000 square km of the earth's surface from radiation emanating from the sun.

27. The method of claim 19, wherein the deploying step comprises the step of imparting a spin on the bubbles.
